(19) United States
(12) Patent Application Publication
(10) Pub. No.: US 2007/0053390 A1
(43) Pub. Date: Mar. 8, 2007

(54) Injection locked diode lasers

(75) Inventors: Ole Klembt Anderson, SP VOORBURG (NL); Coen Theodorus Hubertus Fransiscu Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,317

(22) PCT Filed: Nov. 20, 2003
(86) PCT No.: PCT/IB03/05342

§ 371 Date: Jun. 15, 2005

(30) Foreign Application Priority Data
Dec. 19, 2002 (EP) 02080425.8

(51) Int. Cl. H01S 3/10

(52) U.S. Cl. 372/26

(57) ABSTRACT

A method is provided for modulating the output of a high-power diode laser device (SL) using an injected light signal from a low-power diode laser device (ML). The output of the high-power device (SL) is wavelength modulated by the input signal from the low-power device (ML). In addition, a new optical storage write mechanism is proposed which uses the wavelength modulation technique. Wavelength dependence of the absorption of the recording layer of an optical disc translates the diode laser wavelength modulation into variations of the absorption.

The present invention relates in general to diode lasers. More specifically, the invention relates to a method of modulating output light from a diode laser, to a method of writing information to an optical disc comprising outputting a light signal from a laser diode device, and to an apparatus for producing a modulated light signal, said apparatus comprising a diode laser device.

Diode lasers are an important part of optical storage applications. It is to be expected that dual-stripe diode lasers producing light having a wavelength in a region about 405 nm (blue light) will be available in the near future. Dual-stripe lasers consist of a high-power diode laser and a low-power diode laser in the same mount, separated by a few hundred microns.

Due to their open cavity (that is, a cavity with low-reflectivity facets), high-power diode lasers lend themselves well to the injection of light from, for example, the low-power laser. In this way the high-power laser may be forced, for example, to emit at the wavelength of the low-power laser (wavelength locking).

Write-once read-many media (so-called recordable discs, such as, for example, CD-R and DVD+R) incorporate a dye layer onto which the information is written in the form of a sequence of marks (also referred to as pits). Traditionally this is done by means of a high-power diode laser (DL) of which the current (and hence the output power) is modulated in accordance with a well-defined scheme, the so-called write strategy. Here the amount of energy absorbed by the dye is primarily determined by the output power of the DL. A mark is written by the deposition of enough energy for changing the chemical composition of the dye.

It is therefore desirable, amongst other things, to reduce the amount of output power required to write information to an optical disc.

According to one aspect of the present invention, there is provided a method of modulating output light from a diode laser in which a first diode laser device injects light into a second diode laser device, the second diode laser device producing an output light signal, characterized in that the output light signal has a modulated wavelength dependent upon the injected light from the first diode laser device.

According to another aspect of the present invention, there is provided an apparatus for producing a modulated light signal, the apparatus comprising a first diode laser device operable to produce a first output light signal, and a second diode laser device operable to produce a second output light signal and arranged to receive the first output light signal from the first diode laser device as an input light signal, characterized in that the second output light signal has a wavelength modulated in dependence upon the first output light signal.

In accordance with another aspect of the present invention, a new write mechanism is proposed in which it is not the output power of the high-power diode laser (DL) that is modulated but its wavelength. The wavelength dependence of the dye absorption translates the DL wavelength modulation into variations of the absorption.

It will be appreciated that the principles of the present invention can be applied to modulating the output from a diode laser device of any suitable wavelength, dependent upon the application of the device. Furthermore, although the device mentioned above is a dual-stripe device, the principles of the present invention can be applied to any laser diode device.

In addition, although the optical data storage scheme described above uses a dye-based disc, it will be readily appreciated that the principles of the present invention can be applied to any storage technique in which the absorption of the recording medium changes with the wavelength of the incident light signal.

These and further aspects and advantages of the invention will be discussed hereinafter with reference to the appended Figures, where

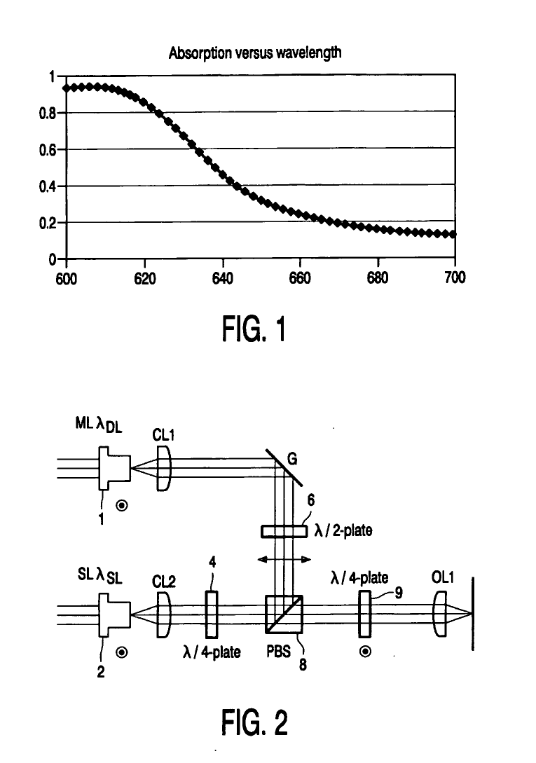

FIG. 1 shows a typical absorption curve for a dye used in DVD+R applications,

FIG. 2 illustrates schematically an apparatus for writing to an recordable disc,

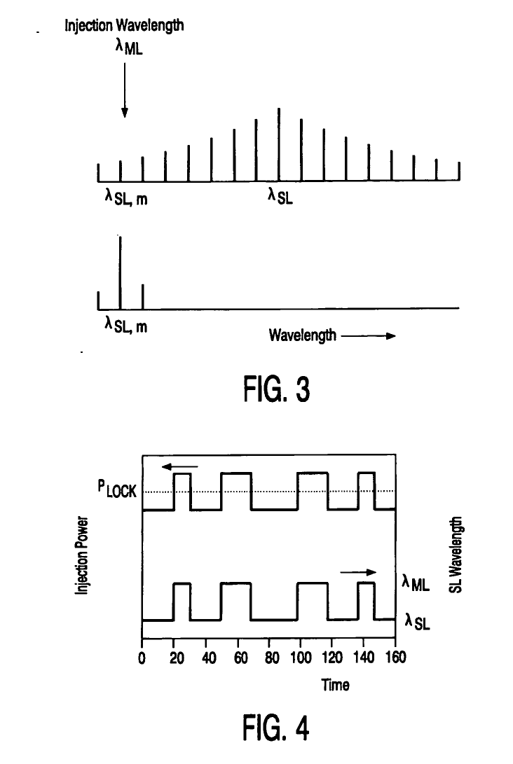

FIG. 3 illustrates emission spectra from respective diode lasers, and

FIG. 4 illustrates wavelength switching of a diode laser.

FIG. 1 illustrates a dye absorption (vertical axis) versus wavelength (horizontal axis) curve, and from this curve it can be seen that wavelength modulation is utilized in a method of writing information to write-once read-many discs embodying the present invention.

FIG. 2 illustrates one example of an apparatus for producing a wavelength-modulated signal from a diode laser. In this example, light output from a low-power diode laser (DL), denoted the master laser (ML) 1, is reflected by means of the polarizing beam splitter (PBS) 8 and injected into a high-power DL, denoted the slave laser (SL) 2. Before the light signal from the ML 1 is injected into the SL 2, its linear polarization is changed to circular polarization by passing the light through a λ/4-plate 4. The ML 1 produces a light signal which passes via a grating G and through a λ/2-plate 6 into the polarizing beam splitter (PBS) 8. The grating serves to reflect the first diffracted order back to the ML 1 in order to stabilize the output of the ML 1. The zero-th diffractive order is reflected towards the SL 2 and is injected into the SL 2 via a λ/4-plate and then a lens CL2. Light output from the SL 2 is output through the lens CL2 and the λ/4-plate 4 to the PBS 8. The light output from the SL 2 passes through the PBS 8 and a second λ/4-plate 9 to an output lens (objective lens) OL1.

The emission spectrum of the SL close to threshold is shown in the upper part of FIG. 3. It consists of several modes symbolized by vertical bars.

Generally, the wavelength of low-power diode lasers is shorter than that of their high-power counterparts. This is symbolized in FIG. 3 with the vertical arrow indicating the position of the wavelength of the ML 1. In the same figure λ_{SL} symbolizes the position of the emission wavelength of the SL 2 above the threshold and without injection from the ML 1. The mode of the SL 2 which is closest to λ_{ML} and at the same time fulfils λ_{ML}-λ_{SL,m}>0 is indicated with λ_{SL,m}. The amount of injected light is determined by the emission power of the ML 1, and when this amount exceeds a certain value P_{LOCK} the wavelength of the SL λ_{SL,m} locks to the wavelength of the ML, i.e. λ_{SL,m}=λ_{ML.} Hence the SL 2 starts to laser with the emission wavelength λ_{ML.} Reducing the emission power of the ML 1 below the locking level causes the wavelength of the SL to return to λ_{SL.}

As the wavelength of the SL 2 is switched between the free-running value λ_{SL} and the injection-locked value λ_{ML}, the absorption of the emitted light from the SL 2 also changes. This is due to the fact that the wavelengths are situated on the slope of the dye absorption curve.

Without injection from the ML 1, a certain amount of light from the SL 2 is absorbed in the dye layer. This amount is proportional to the absorption coefficient α(λ=λ_{SL}) at the wavelength of the SL 2 (without injection). The dependence of a on the wavelength is shown in FIG. 1. When light from the ML I is injected into the SL 2, the wavelength of the SL 2 locks to the wavelength of the ML 1. The absorption of the light from the SL 2 is then proportional to α(λ=λ_{SL,m}=λ_{ML}) Since locking occurs when λ_{SL}-λ_{SL,m}>0, it follows from FIG. 1 that α(λ=_{SL,m})>α(λ=λ_{SL}). When the degree of absorption is large, that is, for α(λ=λ_{SL,m}), a mark is written in the dye and information is thereby stored on the disc.

The use of a method embodying the present invention moves the wavelength of the high-power slave diode laser (DL) in the direction of shorter wavelengths, see FIG. 3. This is a clear advantage because the dye-absorption increases as the wavelength decreases, see FIG. 1. The increased absorption means that less output power from the high-power DL is needed in order to write a mark in the dye. This has consequences for high-speed recording where the amount of emission power needed in order to write a mark increases rapidly with speed. Accordingly, the outlined approach enables higher speeds to be reached with the same amount of DL output power.

In this way the constraints on what type of high-power DLs can be used are also relaxed.

Furthermore, adapting this implementation means that information can be written to recordable discs without modulating the current of the high-power diode laser. It is the current of the low-power diode laser (and hence its emission power) that is modulated, and via injection this is translated into wavelength variations of the high-power diode laser.

It is noted that the present invention may be applied not only to diode lasers producing light having a wavelength in a region about 405 nm (blue light), but also to diode lasers producing light at alternative wavelengths such as, for example, about 650 nm (red light) and about 780 nm (infrared light).

1. A method of modulating output light from a diode laser in which a first diode laser device (ML 1) injects light into a second diode laser device (SL 2), the second diode laser device (SL 2) producing an output light signal, characterized in that the output light signal has a wavelength dependent upon the wavelength of the light injected from the first diode laser device (ML 1).

2. A method as claimed in claim 1, wherein the second diode laser device (SL 2) has an unmodulated output wavelength and a modulated output wavelength, the unmodulated output wavelength being output in the absence of light injected from the first diode laser device (ML 1), and the modulated output wavelength being output in the presence of light injected from the first diode laser device (ML 1).

3. A method as claimed in claim 2, wherein the unmodulated output wavelength is longer than the modulated output wavelength.

4. A method as claimed in claim 1, wherein the first diode laser device (ML 1) is a low-power device.

5. A method as claimed in claim 1, wherein the second diode laser device (SL 2) is a high-power device.

6. A method of writing information to an optical disc comprising outputting a light signal from a laser diode device (SL 2), the light signal being modulated in accordance with a method as claimed in claim 1.

7. A method as claimed in claim 6, wherein the information is written to the optical disc by supplying the light signal to a dye layer in the disc.

8. A method as claimed in claim 6, wherein the information is written to the optical disc by supplying the light signal to a layer in the disc, which layer has a light absorption coefficient that varies with the wavelength of incident light.

9. An apparatus for producing a modulated light signal, the apparatus comprising:
a first diode laser device (ML l)operable to produce a first output light signal; and
a second diode laser device (SL 2) operable to produce a second output light signal and arranged to receive the first output light signal from the first diode laser device (ML 1) as an input light signal,
characterized in that the second output light signal has a wavelength modulated in dependence upon the first output light signal.

10. An apparatus as claimed in claim 9, wherein the second diode laser device (SL 2) has an unmodulated output wavelength and a modulated output wavelength, the second diode laser device (SL 2) being operable to output the unmodulated output wavelength in the absence of light injected from the first diode laser device (ML1) and to output the modulated output wavelength in the presence of light injected from the first diode laser device (ML 1).

11. An apparatus as claimed in claim 10, wherein the unmodulated output wavelength is longer than the modulated output wavelength.

12. An apparatus as claimed in claim 9, wherein the first diode laser device (ML 1) is a low-power device.

13. An apparatus as claimed in claim 9, wherein the second diode laser device (SL 2) is a high-power device.

14. An apparatus as claimed in claim 9, wherein the first diode laser device (ML 1) is operable to inject the first output light signal into the second diode laser device (SL 2) via a polarizing beam splitter (PBS 8).

15. An apparatus as claimed in claim 14, wherein the first output light signal is supplied to the polarizing beam splitter (PBS 8) via a polarization adjustment device (4).

16. An apparatus for writing information to an optical disc, including an apparatus as claimed in claim 9.
